(19) United States
(12) Patent Application Publication
(10) Pub. No.: US 2010/0088202 A1
(43) Pub. Date: Apr. 8, 2010

(54) Handling of Charge Fees On Debt Funded Account Card

(76) Inventor: Dick Carle, Huntington Beach, CA (US)

Correspondence Address: FISH & ASSOCIATES, PC;ROBERT D. FISH, 2603 Main Street, Suite 1000, Irvine, CA, 92614-6232, US

(21) Appl. No.: 12/574,065

(22) Filed: Oct. 6, 2009

Related U.S. Application Data
(60) Provisional application No. 61/103,009, filed on Oct. 6, 2008.

(51) Int. Cl. G06Q 40/00; G06Q 10/00

(52) U.S. Cl. 705/30; 705/38

(57) ABSTRACT

Systems and methods of providing loans are presented. A borrower can obtain a loan where the loan is deposited into an account accessible through an account card. The borrower can participate in a transaction fee reimbursement program where transaction fees incurred through the use of the account card can be reimbursed, possibly by the lender of the loan.

This application claims the benefit of priority to U.S. provisional application Ser. No. 61/103,009 filed Oct. 6, 2008. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is account card technologies.

### BACKGROUND

Payday loan lenders often provide money to borrowers via a financial account having a corresponding account card (e.g., a bank card, debit card, a cash card, etc . . . ). The lender transfers money to the account using electronic fund transfers (EFTS). Typically the amount of money transferred to the account is a desired loan amount less any finance charges. For example, a borrower might request a loan for $300 via a loan application where the service charge for the loan is $45. Upon approval of the application, the lender transfers $255 ($300 minus the $45 service fee) to the account.

Unfortunately, when a borrower uses the card to purchase a good or a service from a vendor, one or more additional transaction fees are applied to a purchase price when conducting a transaction. Typical transaction fees can be on the order of $0.50, $1.00, or even more, per transaction. If the borrower uses the card for many small purchases, the transaction fees can accumulate rapidly, effectively reducing the account balance. The result is that a borrower has access to less money than the original loan amount due to paying for the transaction fees. Additionally, the lender can fall out of compliance with the law due to the excessive costs incurred by a borrower while using the lender's account card to access the loaned money.

Interestingly the loan industry utilizes transaction fees from debit cards as a source of revenue while also allowing borrowers to access funds. Many lenders, or other financial institutions, obtain a substantial portion of their revenues from transaction fees. In fact, much effort has been placed toward ensuring that financial institutions obtain their fees. For example, U.S. Patent Publication 2008/0103970 to Books et al. titled “Debit Card System Loan Provisions” filed on Oct. 29, 2007, describes that funds are provided only after a card holder has been notified of any potential fees. By notifying the card holder of potential fees before lending, Books hopes to maintain compliance with Truth-In-Savings Act regulation DD.

In an industry where the norm is to generate revenue by extracting excessive transaction fees for the use of a debit card or other account card, it is no wonder the industry have failed to consider, at least until now, offering a reimbursement to the borrower for incurred transaction fees. A lender could offer to reimburse the borrower for transaction fees when using the account card to reduce the costs to the borrower or to maintain compliance with applicable laws. The borrower can submit proof of the transaction fees incurred back to the lender, and the lender can credit the borrower's account for a reimbursement amount corresponding to at least portion of the transaction fees. The outlined approach is counter to the trend taken by the industry, yet reduces costs to the borrower and ensures a lender continues to comply with applicable laws.

Thus, there is still a need for systems or methods of providing a borrower a loaned amount of money, where the amount can be protected against undesirable transaction fees.

### SUMMARY OF THE INVENTION

The inventive subject matter provides apparatus, systems and methods in which a loan can be provided to a borrower where the borrower can access loaned funds through an account card, where transaction fees stemming from transactions using the account card can be reimbursed.

One aspect of the inventive subject matter includes methods of providing a loan. Preferred methods include providing an account card to a borrower that is associated an account, possibly hosted by an account server operated by a bank, a loan lender, or other financial institution. The account card can be encoded with an account identifier that identifies the account. The identifier is preferably encoded on the card in a machine readable format, a magnetic strip for example. When a borrower applies for a loan from a lender, a lender server operated by the lender can use an account identifier to interact with an account server. Preferably, the lender server deposits a loan into the account via an interaction with the account server based on the account identifier.

In a preferred embodiment, one or more offers are provided to a borrower to join a transaction fee reimbursement program. The program can include reimbursing transaction fees incurred when using the account card to conduct transactions against the loaned amount of money. If the borrower accepts such an offer, and the borrower provides proof of the transaction fee (e.g., receipts, authentication, copies of receipts, etc.), the lender server can be configured to deposit a reimbursement amount that corresponds to at least some of the transaction fees back into the borrower's account, again by interacting with the account server based on the account identifier. The lender server could reimburse a portion of a single fee, a single fee, multiple fees, or other combination of fees.

It is also contemplated that an on-line account interface can be provided to a borrower. The account interface can be used to check the status of the borrower's account including information relating to when transaction fees have been or will be reimbursed. Preferably a lender server provides the on-line account interface. Furthermore, the lender server can be configured to send a notification to the borrower that the transaction fees have been reimbursed, possibly by sending an electronic communication, a written statement, or other communiqué.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic of a possible loan processing system capable providing reimbursement for transaction fees.

FIG. 2 is a schematic of a possible method for providing a loan.

### DETAILED DESCRIPTION

The following discussion describes a computer based loan processing system that employs various computing devices including servers, interfaces, systems, databases, or other types of computing devices operating individually or collectively. One should appreciate the computing devices comprise a processor configured to execute software instructions stored on a computer readable storage medium (e.g., hard drive, RAM, flash, ROM, etc.). The software instructions preferably configure the computing device to provide the roles, responsibilities, or other functionality as discussed below with respect to the specific apparatus. In especially preferred embodiments, the various servers, systems, databases, or interfaces exchange data using standardized protocols or algorithms possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

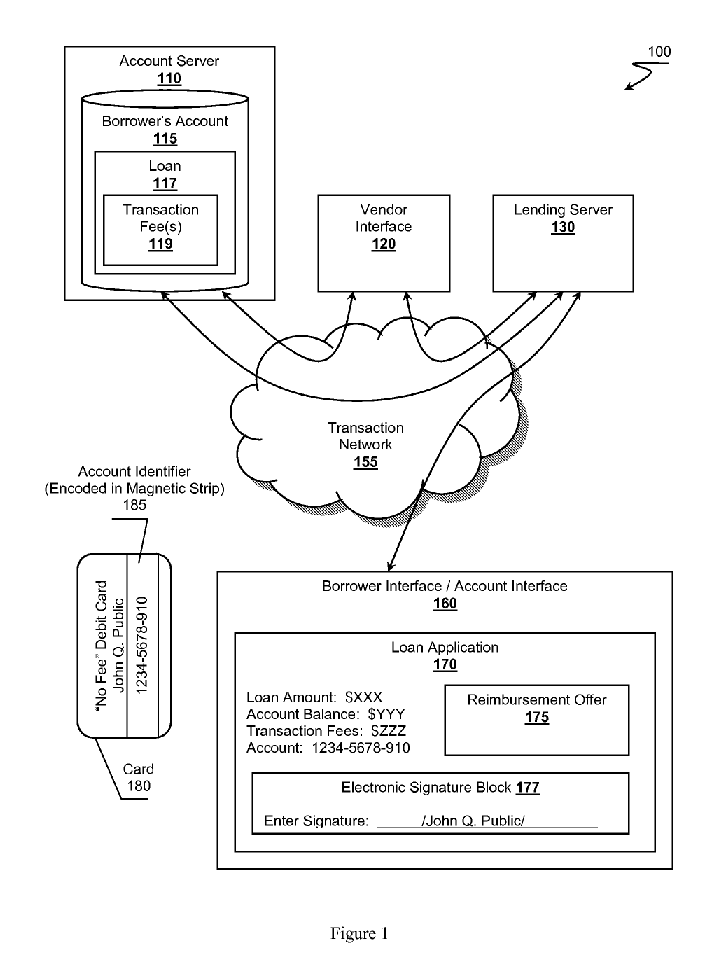

In FIG. 1, loan processing system 100 can comprises account server 110, vendor interface 120, lender server 130, transaction network 155, and borrower interface 160. In a preferred embodiment, account card 180 is also included to identify borrower's account 115.

It should be appreciated that transaction network 155 represent a communication network among the members of system 100. Network 155 could be a packet switched network (e.g., the Internet), a phone network, existing financial networks, or other networks that provide for data communications among the devices of system 100.

A lender, preferably a lender that operates lender server 130, provides loan 117 to a borrower. The borrower can access the funds from loan 117 in account 115 by using account card 180. Preferred account cards 180 correspond with borrower's account 115 hosted on account server 110. Account server 110 could be operated by the same vendor or a different financial institution. It is also contemplated that account server 110 could also be lender server 130. Borrower's account 115 can be managed by the lender or by another different entity over network 155 as desired.

Account card 180 could include a debit card, a cash card, a bank card, credit cards, or other types of cards that can be coupled to account 115. Preferred cards 180 are encoded with account identifier 185. Preferably account identifier 185 is encoded in a machine readable media, possibly a magnetic strip, RFID tag, a memory, or other computer readable media. Account identifier 185 can be used by the various members of system 100 to identify account 115 and to interact with account server 110 to deposit or withdraw funds from account 115. Furthermore, account card 180 preferably represents “no fee” card, where a card user can recoup transaction fees incurred due to use of the card after issuance of the card or issuance of the loan.

To obtain loan 117, in a preferred embodiment, lender server 130 provides loan application 170 to a borrower through borrower interface 160, possibly as a web page. Loan application 170 can comprise various information relating to aspects of a loan. For example, loan application 170 can include information about the borrower, the current loan, previous loans, transaction fees, account information, or other data. If the borrower wishes to submit loan application 170 to lender server 130, the borrower can supply an electronic signature, or other signature, in electronic signature block 177. Preferably the electronic signature authorizes one or more EFTs to account 115. Preferred EFTs include involving depositing loan 117, depositing reimbursements for transaction fees 119, or other transfers. Use of electronic signatures to authorized EFTs is discussed in co-pending U.S. patent application Ser. No. 12/574,038 titled “Preauthorized Electronic Fund Transfer For Future Cash Advances” filed on Oct. 6, 2009.

Upon approval of a borrower's loan application 170, the lender can deposit loan 117 into the borrower's account 115 preferably via an EFT interaction between lender server 130 and account server 110 based on account identifier 185. Preferred loan amounts for loan 117 are no greater than $500, or more preferably no greater than $300. Especially preferred loans 117 are payday loans.

In a preferred embodiment, the lender offers to reimburse the borrower for any transaction fees 119 incurred while using card 180. In some embodiments, loan application 170 can include reimbursement offer 175 that offers a borrower an option to earn back lost transaction fees. In other embodiments, the offer could include an advertisement offered on-line, possibly within a web page. Preferred offers 175 provide a borrower

Once loan 117 is deposited in account 115, the funds are available to a borrower. The funds can be accessed through conducting transactions with account card 180. For example, a borrower could use account card 180 to purchase a small ticket item from a vendor, a gallon of milk for example. The vendor could use vendor interface 120 to interact with account server 110 to withdraw funds from account 115. Vendor interface 120 could comprise a computer, a magnetic strip reader, an RFID reader, or other card reader. Unfortunately, the vendor could also charge transaction fees 119 which are also withdrawn from account 115. More importantly, transaction fees 119 can be drawn from the funds provided by loan 117, which is undesirable as discussed above.

If a borrower is participating in a reimbursement program, the borrower could supply proof to a lender that transaction fees 119 where incurred. Proof could include physical proof, possibly comprising physical receipts. Proof could also include digital proof comprising digital renderings of the receipts, faxed copies of the receipts, statements or certified statements by a vendor, account statements, or other digital information that can be used to confirm transaction fees 119 where incurred. In one preferred embodiment, the borrower electronically submits proof to lender server 130.

Upon approval of the submitted proof, a lender can reimburse transaction fees 119 through numerous suitable methods. In a preferred embodiment, the lender can reimburse the borrower by causing lender server 130 to deposit a reimbursement amount corresponding to at least a portion of transaction fees 119 into borrower's account 115. For example, lender server could perform an EFT with account server 110 based on account identifier 185 to place the funds in borrower's account 115. In other embodiments, a check could be issued to the borrower, or a credit could be applied to pay back loan 117.

In a preferred embodiment, the borrower is notified that transaction fees have been reimbursed. The borrower can be notified through a physical account statement mailed to the borrower. However, in a more preferred embodiment, the borrower can be notified through sending an electronic account statement showing a credit of the reimbursement amount via an electronic transmission (e.g., web page, email, etc . . . ). For example, borrower interface 160 could be configured as an on-line account interface, preferably configured by lender server 130, to present the status of account 115. It is also contemplated, that the on-line account interface can provide details relating to the status of transaction fees 119. The transaction fee state could include number of fees, time or date when fees were incurred, information about the vendor that charged the fee, amount of the fees, time or status of reimbursement, an indication if the fee is eligible for reimbursement, or other information relating to transaction fee 119.

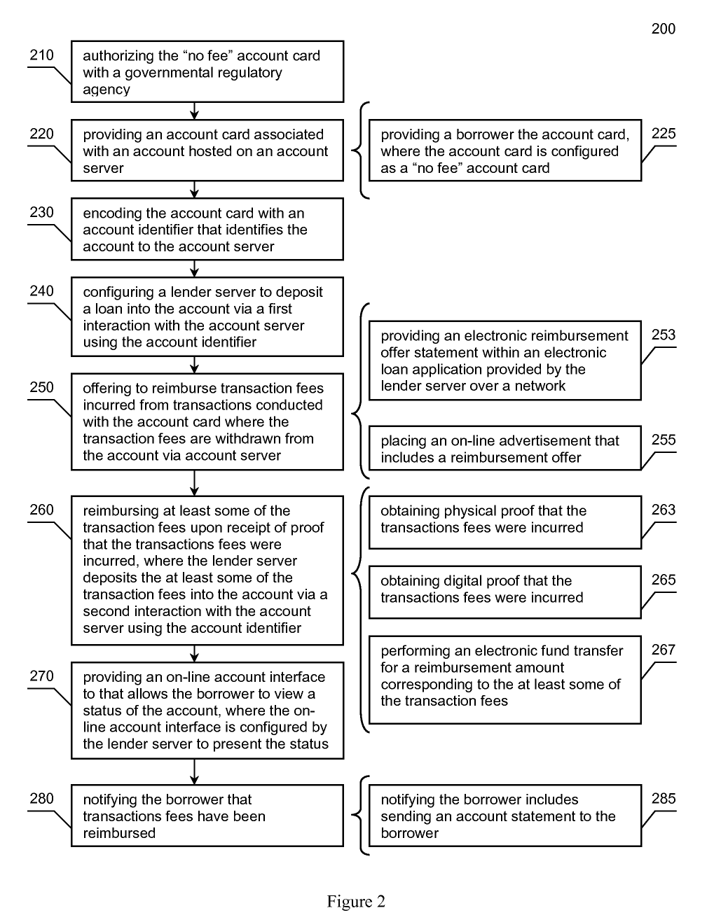

In FIG. 2, method 200 outlines a possible method for providing a loan where funds from the loan can be accessed via an account card in order to conduct a transaction. Transaction fees incurred can be reimbursed to a borrower of the loan.

In some embodiments, method 200 includes step 210 where a lender interacts with a governmental regulatory agency (e.g., federal, state, city, etc.) to authorize use of an account card that can be used to reimburse transaction fees. Preferably, step 210 includes authorizing the account card program as a “no fee” account card with the governmental regulatory agency. A reimbursement program could be deployed in the market a lender issuing such account cards to borrowers.

Step 220 can include providing the account card to a borrower, where the account card is associated with a borrower's account, preferably hosted by an account server. In a preferred embodiment, at step 225, the account card is configured as a “no fee” account card. The account card can encode additional information, possibly as part of the account identifier, which indicates the borrower is participating in the reimbursement program.

Step 230 can include encoding the account card with an account identifier that identifies the account to the account server. As a borrower uses the account card to conduct transactions, a computing device (e.g., a card reader, RFID reader, etc.) reads the account identifier from a computer readable media. The computing device can then provide the identifier to the account server so that a transaction can be conducted with respect to the account. An account identifier could be supplied by a borrower, generated by an account server or a lender server, or otherwise provided or assigned.

Step 240 can include configuring a lender server, preferably a server operated by the loan lender, to deposit a loan into the account of the borrower. The lender sever can use the account identifier to conduct an EFT with the account server to ensure the deposit is made. In a preferred embodiment, the loan is deposited after reception of and approval of a loan application.

Step 250 can include offering to reimburse transaction fees incurred from transactions conducted with the account card, especially transaction fees that are withdrawn from the borrower's account as part of a charge for a transaction. In some embodiments, as discussed previously, step 253 can include providing an electronic offer statement within an electronic loan application provided by the lender server over a network. In other embodiments, step 255 can include placing an on-line advertisement that includes a reimbursement offer. All forms of providing an offer for a borrower to participate in a transaction fee reimbursement program are contemplated.

Step 260 can include reimbursing at least some of the transaction fees. Preferably, reimbursement for the fees is provided upon receipt of proof that the transaction fees were indeed incurred or changed to account. Reimbursement, after suitable approval of the proof, can be achieved by a lender server interacting with an account server, possibly based on an account identifier. In some embodiments, at step 263, the proof is obtained by receiving some form of physical proof, paper receipts for example. It is also contemplated, at step 265, the proof could be obtained from a borrower in digital form (e.g., a fax, a scan, a biometric, a certification from a vendor or account server, etc.). Once proof is obtained and approved, at step 267 a lender server could conduct a EFT with an account server to deposit a reimbursement amount back into the borrower's account, The reimbursement amount preferably is less than or equal to the transaction fee amount. It is also contemplated that the reimbursement program could have a cap on the amount of reimbursements provided, possibly based on a finance charge for the loan. For example, no more than half of a loan fee would be reimbursed through the transaction fee reimbursement program.

Step 270 can include providing an on-line account interface, through which a borrower can monitor or interact with their account. Preferably the on-line account interface allows the borrower to view the status of the account, or possibly the status of reimbursements. In such an embodiment, it is contemplated that a lender server could provide the on-line account interface. For example, the lender server could cause a computer to render a web page providing the status information, possibly as a report, statement, or other presentation.

Step 280 can include notifying a borrower that a transaction fee has been reimbursed. For example, the notification could include sending an account statement having the transaction fee status to the borrower as depicted in step 285. It is also contemplated, that transaction fee reimbursement notifications could be sent electronically through any suitable means. A transaction fee reimbursement notification could be sent through email, web page, twitter, instant messaging, SMS messages, or other notifications.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of providing a loan, the method comprising:
providing an account card associated with an account hosted on an account server;
encoding the account card with an account identifier that identifies the account to the account server;
configuring a lender server to deposit a loan into the account via a first interaction with the account server using the account identifier;
offering to reimburse transaction fees incurred from transactions conducted with the account card where the transaction fees are withdrawn from the account via account server; and
reimbursing at least some of the transaction fees upon receipt of proof that the transactions fees were incurred, where the lender server deposits the at least some of the transaction fees into the account via a second interaction with the account server using the account identifier.

2. The method of claim 1, wherein the step of reimbursing the at least some of the transaction fees includes performing an electronic fund transfer for a reimbursement amount corresponding to the at least some of the transaction fees.

3. The method of claim 1, further comprising obtaining physical proof that the transactions fees were incurred.

4. The method of claim 3, where the physical proof includes physical receipts from the transactions.

5. The method of claim 1, further comprising obtaining digital proof that the transactions fees were incurred.

6. The method of claim 1, further comprising providing an on-line account interface configured to allow a borrower view a status for the account, where the on-line account interface is configured by the lender server to present the status.

7. The method of claim 1, wherein offering to reimburse the borrower includes providing an electronic reimbursement offer statement within an electronic loan application provided by the lender server over a network.

8. The method of claim 1, wherein offering to reimburse the borrower includes placing an on-line advertisement that includes a reimbursement offer.

9. The method of claim 1, wherein the loan amount is no greater than $500.

10. The method of claim 9, wherein the loan amount is no greater than $300.

11. The method of claim 1, further comprising notifying a borrower that the transactions fees have been reimbursed.

12. The method of claim 10, wherein the step of notifying the borrower includes sending an account statement to the borrower.

13. The method of claim 11, wherein the account statement is in an electronic format.

14. The method of claim 1, further comprising providing a borrower the account card, where the account card is configured as a “no fee” account card.

15. The method of claim 14, further comprising authorizing the “no fee” account card with a governmental regulatory agency.
